(19) United States
(12) Patent Application Publication
(10) Pub. No.: US 2011/0252437 A1
(43) Pub. Date: Oct. 13, 2011

(54) ENTERTAINMENT APPARATUS

(76) Inventors: Kate Smith, London (GB); Jonathan Smith, London (GB)

(21) Appl. No.: 12/756,378

(22) Filed: Apr. 8, 2010

(51) Int. Cl. H04N 7/025; H04N 5/64

(52) U.S. Cl. 725/1; 348/840; 725/32; 348/E05.128

(57) ABSTRACT

A video pod comprises side wails and a roof; a first display device inside the video pod; a second display outside and above en opening to the pod; a payment device; an input device; and a memory storing a plurality of video programs. The first display device is arranged to display a selected one of said video programs upon payment via the payment device and selection via the input device by a user, and the second display device is arranged to display a promotional video different to the video programs.

### FIELD OF THE INVENTION

The present invention relates to entertainment apparatuses, and especially entertainment apparatuses suitable for small children.

### BACKGROUND OF THE INVENTION

The children's entertainment industry is well-recognized and long-established. This important sector of the economy includes television and film and there are many well-loved children's cartoon and other fictional characters, both in television programs and in films. Such characters, films and programs also generate a large merchandising industry for dolls and toys associated with them. Advertisers have long sought to associate their products with such characters, programs and films. However, in many jurisdictions there are strict guidelines governing the content and amount of advertising that can be tied in with them. For example, the number and type of adverts shown with children's television programs is often regulated.

Entertainment rides for small children of the type commonly found at shopping malls and supermarkets have also been known for a long time. Typically such devices comprise a plastic molding in the shape of a well-known children's character, or another shape appealing to children, with a place for the child to sit. The rides normally comprise a speaker to emit music and speech associated with the cartoon character, and flashing lights to add excitement to the child's experience. In addition, most such rides include moving parts to provide the child with the experience that they are taking a ride or going on a journey.

Although popular, such entertainment apparatuses have the disadvantages that children quickly become bored with them, or grow out of liking the character with which they are associated; that the moving parts require maintenance and are prone to break down; and that molding of the external parts is expensive and difficult, with a different mould being required for each character or shape. Moreover, parents and carers tend to see the time they spend waiting for their child on the ride as dead or wasted time, especially if the child has been on the ride several time before or there are two or more children taking turns on the ride.

### SUMMARY OF THE INVENTION

According to a first aspect of the present invention, there is provided a children's entertainment apparatus comprising: an enclosure comprising first and second side walls opposite one another, a back wall disposed between the first and second side walls, and a root a first display device arranged to show video and provided inside the enclosure, a viewing space being provided inside the enclosure for viewing the first display apparatus; and a second display device arranged to show video and provided on the roof.

Preferably, a centerline of the second display device being disposed substantially at eye height of a normal human adult and more preferably the centerline is disposed between 1 m and 2 m from a bottom of the apparatus. Yet more preferably, the centerline is disposed between 1.3 m and 1.7 m from the bottom of the apparatus.

The first display device may be a touch screen arranged to provide menu options for selecting the video to be shown on at least the first display device.

The apparatus may further comprise a control for selecting the video to be shown on the second display device, the control preferably being the first display device.

In a preferred embodiment, the apparatus comprises a Bluetooth device. It is preferred that a range of transmission of the Bluetooth device being substantially within a radius of 2 m of the apparatus. It is preferred that the Bluetooth device is arranged to transmit promotional messages and, on receipt of a predetermined response, to cause the entertainment apparatus to print a promotional voucher.

In a preferred embodiment, the apparatus comprises a printer arranged to print promotional vouchers.

Preferably, an opening is disposed opposite the back wall, whereby a carer of a child can see a child in the viewing space. In this case, it is advantageous for the second display apparatus to be disposed above the opening.

Preferably, the maximum height of the apparatus is less than 1.7 m.

The apparatus may also comprise a removable memory card on which the video is substantially stored.

According to another aspect of the invention, there is provided a video pod comprising: side walls and a roof; a first display device inside the video pod; a second display outside and above an opening to the pod; a payment device; an input device; and a memory storing a plurality of video programs, the first display device being arranged to display a selected one of said video programs upon payment via the payment device and selection via the input device by a user, and the second display device being arranged to display a promotional video different to the video programs.

At least the side walls may be covered in a vinyl wrap.

The pod according may further comprise a dispenser for dispensing a voucher for a promotion.

In addition, at least the side walls may be covered in a vinyl wrap comprising a promotional image, and the pod may further comprise a dispenser for dispensing a voucher for a promotion associated with the promotional image.

The promotional video displayed by the second display device may correspond to the selected video program.

The present invention also provides a method for promoting articles, comprising: providing at least one of a children's entertainment apparatus and a video pod; disposing a promotional image on the outside of the at least one of the children's entertainment apparatus and the video pod; causing the first display screen to show a video associated with the promotional image; and causing the second display screen to display an image associated with the promotional image.

The method may further comprise causing a dispenser to dispense a voucher associated with the promotional image.

### BRIEF DESCRIPTION OF THE DRAWINGS

Embodiments of the present. Invention will now be described by way of further example only and with reference to the accompanying drawings, in which:

FIG. 1 is a perspective view from the left and front of a video pod according to the present invention;

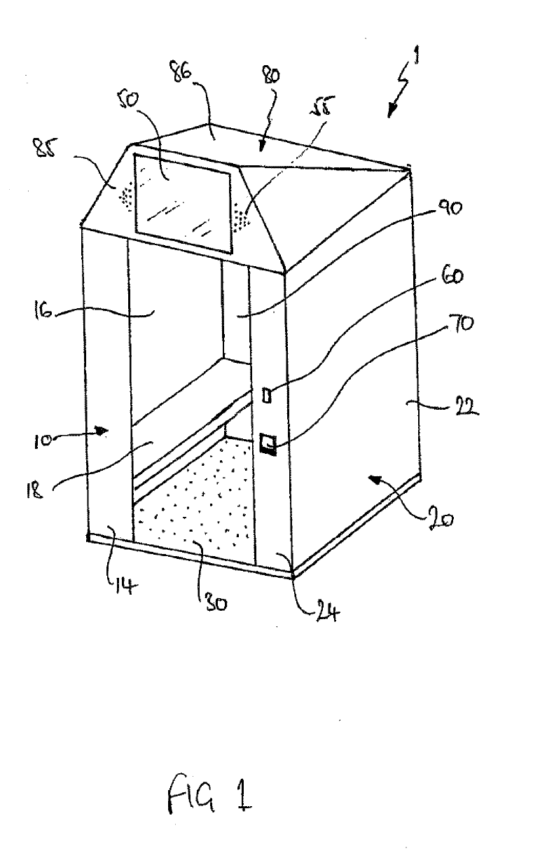

FIG. 2 is a perspective view from the right and front of the video pod;

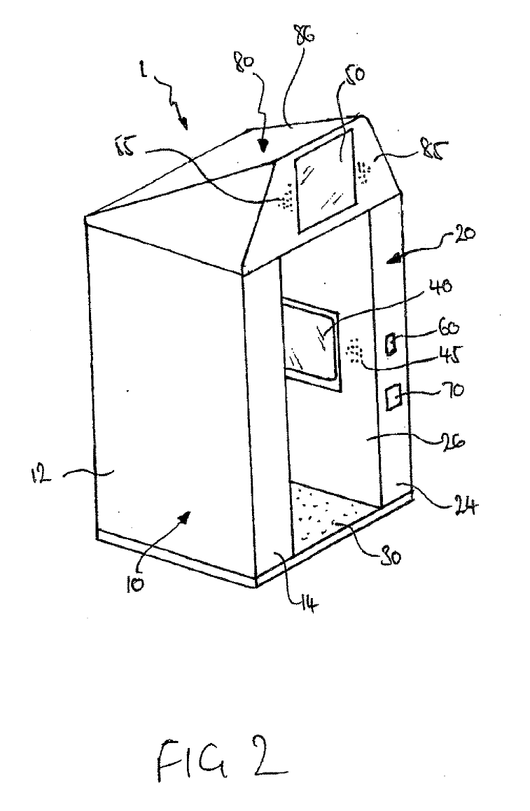

FIG. 3 is a block diagram illustrating the constitution of the electronics of the video pod; and

FIG. 4 is a perspective view showing the video pod in use.

### DETAILED DESCRIPTION

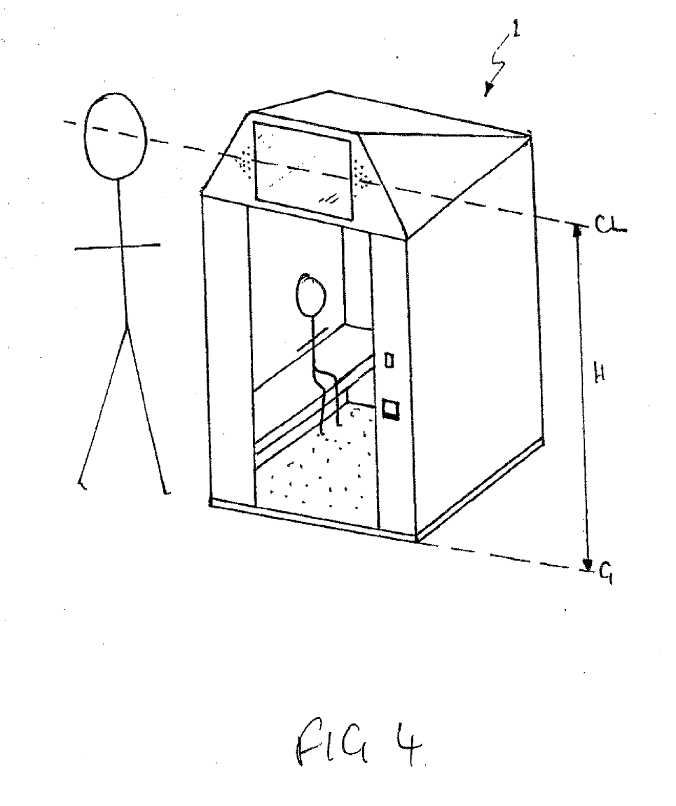

In one embodiment, as shown in the drawings, the present invention comprises a video pod 1, which acts as an entertainment apparatus for children, preferably of 2-6 years old. In particular, when a child or the child's parent or other care-giver pays money into the machine, the child is able to select a short video such as a cartoon to watch inside the pod 1 while the child's parent waits outside (as shown in FIG. 4). In this specification, where a video is shown it should be assumed that associated audio may also be output (although this is not essential). Typically, the pod 1 will be found in supermarkets or shopping malls and are a treat for children as they accompany their parents shopping. However, there are many other suitable locations including but not limited to holiday camps, amusement parks, play centers and travel hubs.

The pod 1 has a non-slip safety floor 30, first and second side walls 10 and 20, which extend from the front to the back of the pod 1 in a depth direction, a back wail 90 which extends between the side walls 10, 20 and a roof BO covering the whole. Thus, the pod 1 forms a viewing enclosure partially isolated from the outside world with an opening at the front between the side walls 10, 20. The pod 1 is painted using anti-bacterial paint.

Each of the side walls 10, 20 has an external side surface 12, 22, a front surface 14, 24 and an internal surface 16, 26, An inner LCD touch screen 40 is provided on the internal surface 26 of the second side wall 20 and a bench 18 is disposed on the internal surface 16 of the first side wall 10. Speakers 45 are also disposed inside the pod 1, preferably adjacent the inner LCD screen 40. The bench 18 is disposed opposite the inner screen 40. The inner screen 40 and the bench 18 are sized and disposed at respective heights above the ground such that an average child of 2-6 years old can sit on the bench 18 and watch video displayed on the inner screen 40, as shown in FIG. 4.

A payment device 60, in particular a coin slot device, and an output slot 70 are provided on the front surface 24 of the second side wall 20.

In addition, an outer LCD screen 50 and associated speakers 55 are provided on the outside of the pod 1, more particularly on the front wall 85 of the roof 80 directly above the opening to the pod 1. The centerline CL of the outer screen 50 is disposed at a height H above the ground G (see FIG. 4) such that it is can be conveniently viewed by a normal adult, Preferably, the centerline CL is between 1 m and 2 m above the ground, more preferably between 1.2 m and 1.7 m, and yet more preferably between 1.4 and 1.6 m.

Preferably the pod has a footprint of 750 mm×900 mm, with a maximum height of 1647 mm.

When payment is made via the payment slot 60, the inner screen 40 is activated and displays a menu of video programs that the child can view for the payment made. The child (or parent) selects a desired program by pressing the appropriate menu button(s) displayed on the inner LCD touch screen 40. The inner screen 40 is then controlled to show the selected program to the child inside the pod 1. Naturally, the audio accompanying the selected program is provided by the speakers 45. Meanwhile, the parent accompanying the child waits outside the pod 1 and predetermined promotional material is displayed to the parent via the outer screen 50 and the associated speakers 55.

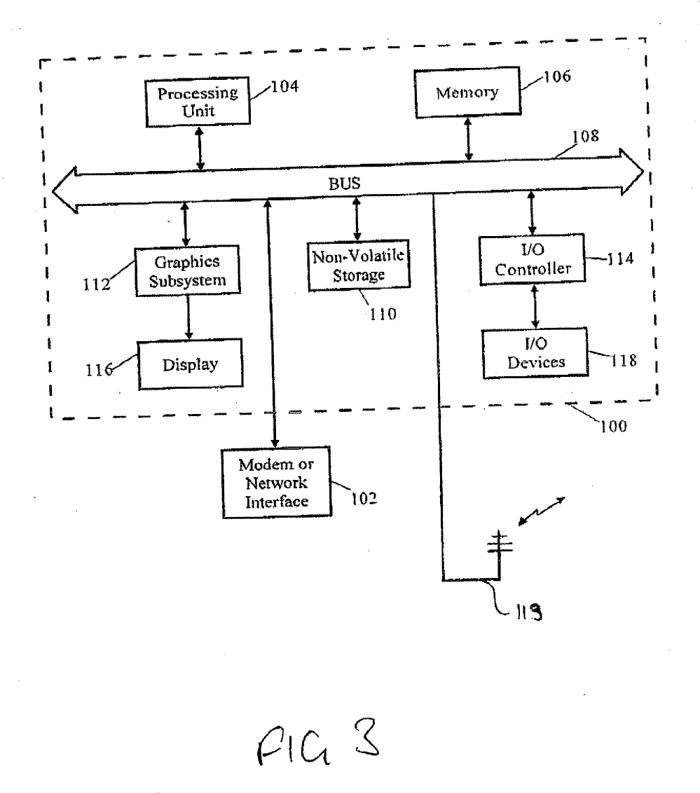

FIG. 3 illustrates an exemplary embodiment of a computer system 100 that may be used to control the pod 1. Computer system 100 may form part of a desktop computer or a laptop computer, or any similar computer device, but is preferably permanently mounted inside the second side wall 20 or at any other convenient location within the pod 1.

The computer system 100 may but need not interim to external systems through a modem or network interface 102, such as an analogue modem, ISDN modem, cable modem, token ring interface, or satellite transmission interface, As shown in FIG. 3, the computer system 100 includes a processing unit 104, which may be a conventional microprocessor, such as an Intel Core Duo microprocessor, or another microprocessor, which are known to one of ordinary skill in the computer art. System memory 106 is coupled to the processing unit 104 by a system bus 108. System memory 106 may be a DRAM, RAM, static RAM (SRAM) or any combination thereof, Bus 108 couples processing unit 104 to system memory 106, to non-volatile storage 110, to graphics subsystem 112 and to input/output (I/O) controller 114. Graphics subsystem 112 controls the inner and outer screens 40, 50, shown generically as display device 116 in FIG. 4, which may be part of the graphics subsystem 112.

The I/O devices 118 in the preferred embodiment include a thermal printer having an output via the return slot 70, the speakers 45, 55, the payment slot 60, and the inner touch screen 40 for receiving control inputs. The I/O devices 118 could also include any one or more of a keyboard, disk drives, a mouse and the like as known to one of ordinary skill in the computer art.

Some or all of the control software will normally be stored on the non-volatile storage 110, which may be a hard drive. However, some or all of the control software may also be stored on an externally connectable storage medium, such as a flashcard, a USB memory stick or a CD. These devices would then constitute part of the I/O devices shown as item 118 in FIG. 4.

In the present embodiment, at least the video program data for the inner screen and the promotional material data for the outer screen are stored on en externally connectable 2 GB flashcard. Some or all of the control software may also be provided on the flashcard.

In practice, the processing unit will receive a signal from the payment slot device 60 indicating that payment has been made, Acting on the control software and the video data stored on the 2 GB flashcard, the processing unit 104 will cause the graphics system 112 to display the menu on the inner touch screen 40. Upon receiving the user selection on the touch screen 40 via the 110 controller 114, the processing 104 unit will drive the graphics subsystem 112 to cause the inner screen 40 to show the selected video. The processing 104 unit will also drive the graphics subsystem 112 to cause the outer screen 50 to display the predetermined promotional material.

The payment slot device 60 is preferably a coin slot device adapted to count the monetary value of coins fed into the slot and feed the result to the computer system 100. However, the payment slot device 60 may alternatively or also be a credit card, wireless RFID card or other payment device and corresponding control routines may be built into the computer system (including the payment device 60 as an I/O device 118). In the preferred embodiment, the computer system 100 can be controlled to vary the price for displaying a video, or may cause the inner LCD screen 40 to display a menu option in which two or more videos are displayed for a predetermined price.

Since the pod is only 1647 mm high, there are no sightline restrictions so a normal adult can see over the pod. Moreover, the provision of a vertical front face 85 on the roof, in which the outer screen is disposed, and sides 86 that slope from the top of the front face 85 towards the back of the pod 1 means that an adult of normal height can more easily see over the top of the pod. The low height of the pod, combined with the footprint of 750 mm×900 mm, means that the pod 1 is small, This is attractive to younger children and does not provide too imposing a presence in shopping malls and the like. Furthermore, the small size means that the pod 1 is easily transportable and, since all the electronics are self-contained within the pod, the pod 1 can easily be installed at any chosen location so long as there is a power socket, in addition, the small footprint is advantageous as the rental value for locations in which the pod will most likely be sited is generally calculated as a payment amount per unit area, for example US$ per square foot. Despite the small size, two children can sit comfortably on the bench 18 at the same time.

A further advantage is that the pod 1 has substantially no moving parts and is therefore less prone to breakdown than prior art children's rides.

In the preferred embodiment, at least the external side surfaces 12, 22 of the first and second side walls 10, 20 are decorated to show the videos available for display in the video pod. In particular, the side walls are decorated with images from well-loved children's television programs and films from which the videos are taken in order. The outer screen 50 and speakers 55 may also output images and sounds from or reminiscent of those programs and films to advertise the pod's video content. This causes children of the age group those programs and films are aimed at, typically 2 to 5, to request their parents to allow them to see a video. In the same way that they will allow their children a go on the traditional children's rides found in supermarkets and shopping malls, parents will also allow their children to view a video in the manner described above.

Typically, the pod 1 will store as videos four different episodes from each of four different children's programs or films. To prevent the parent being unwilling to allow a child to see a video because it would be too time-consuming, it is preferred that the episodes are edited to shorten them. For example, if a typical episode includes seven story lines but lasts ten minutes, the episode can be shortened to a more preferable length, such as five minutes, by cutting a number of the storylines, while still providing a complete, self-contained program.

When payment is made, the inner touch screen 40 displays a first menu showing the four different characters or programs as options. Once one of the characters or programs is selected, the inner touch screen 40 displays a second menu showing the four different episodes as options. The selected episode is then screened.

In one aspect of the invention, the present inventors have recognized that, while the child is watching the selected video on the inner screen 40, the parent will be standing in front of the opening to look after the child, in particular to ensure that the child does not leave without the parent seeing, and to prevent others accessing the pod 1 while it is the child's turn. Thus, the parent is a captive audience and will be receptive to a distraction while they are waiting.

Moreover, the present inventors have recognized that the pod can be sized and designed so a child of 2-6 years old can comfortably view videos inside the pod 1, while the accompanying parent can comfortably view promotional and another material on an outer screen 50 outside the pod 1. In particular, the pod 1 can be designed so that both the video inside the pod land the promotional material outside the pod 1 can be viewed without adversely impacting on one another—that is, neither mars the viewing experience of the other, or at least not to any significant extent. Moreover, the specific application of the pod 1 to screening videos for children mean that it can be dimensioned so that a parent can both look after a child inside the pod 1 and at the same time view promotional material on the outer screen, without either activity being compromised, as shown in FIG. 4. It is noteworthy that the pod can be dimensioned and designed so that the centerline CL of the outer screen 50 is at a height H above the ground C that is comfortable for a standing adult to view without stooping or bending their neck.

The present invention is particularly advantageous in that the parent is a captive audience and, moreover, will most likely come from a specific demographic—that is, the viewer of the outer screen 50 will be a parent or care-giver of a young child and will most likely be 16-35 years old, This demographic is particularly sought after by advertisers, who will immediately recognize the commercial benefits available from the video pod 1 of the present invention. Thus, the video pod 1 will provide at least two streams of revenue—first, money taken via the payment slot in payment for viewing videos on the inner screen 40; and second, money paid by advertisers to screen promotional material on the outer screen 50.

Because all the video programs for display by the inner screen 40 and promotional material for display by the outer screen 50 is stored on a removable fiashcard 110, it is a simple matter to update both the videos and the promotional material. The videos and promotional material can also be provided on separate flashcards, so that they can easily be updated independently.

Accordingly, the pod 1 can be easily and regularly updated, thereby maintaining its appeal and relevance to children. Moreover, because a range of programs can be sold, the pod will appeal to a larger age-range of children. The simple shape of the pod allows it to be rebranded, for example to indicate that it is showing different or new programs and/or episodes by the expedient and simple means of applying a pre-printed vinyl wrap to one or more external side surfaces 12, 22 of the pod 1.

Although not essential in the invention, the present embodiment further comprises a Bluetooth transmitter and receiver 119 (see FIG. 3) and a thermal printer as one of the output devices 118. The thermal printer 118 and Bluetooth device 119 can act together to provide promotions. For example, the Bluetooth device 119 may transmit to within a radius of 2 m of the pod 1. When a video begins to be shown by the inner screen 40, the Bluetooth transmitter 119 transmits messages, asking whether a person receiving the message via their mobile phone or other portable, Bluetooth-enabled device would like to receive a marketing message. If the person receiving the message indicates that they are willing to receive the marketing message, the control system 100 will cause the Bluetooth transmitter 119 to transmit a marketing message. The marketing message may offer, for example, one or more vouchers or discounts for use in the supermarket, shopping mall or elsewhere. If the person replies that the or a particular voucher or discount is required, the control system 100 will cause the printer 118 to print a voucher. The voucher is output via the output slot 70, which may also double as a coin return slat. Alternatively separate printer output and coin return slots may be provided. In the preferred embodiment, the pod 1 stores three voucher templates at any one time.

Typically, the voucher will be a discount voucher for an item sold by the supermarket in which the pod 1 is located, or sold by one of the shops in the mall in which the pod 1 is located. For example, the voucher may be for a free coffee, a buy-one-get-one-free (BOGOF) promotion, a 10% discount on same day purchases and so forth. Of course, the voucher could be for different goods and services, whether or not offered in the supermarket or shopping mall Accordingly, the pod 1 allows retailers and others to directly target consumers in a highly sought-after demographic, and further provides pod owners with an additional source of revenue from such retailers wishing to run promotions via the pod 1.

The promotional material displayed on the outer screen 50 may be controlled in dependence on the videos that can be or are being shown on the inner screen 40. For example, if the pod can show videos from a well-known children's program, the promotional material displayed on the outer screen 50 may be directly related to the program and may include merchandise for that program. The merchandise may be available from the supermarket or shopping mall in which the pod is situated.

Alternatively, the outer screen 50 may be controlled to display promotional material directed to a child while the pod is not in use and there is no adult captive audience, and to display promotional material directed to an adult while the pod is in use and there is a captive adult. Here, the promotional material directed to the child may be short excerpts of some or all of the videos available for viewing inside the pod.

Thus, it will be appreciated that the promotional material displayed on the outer screen 50 can be controlled in a number of different ways to meet a variety of different demands. It should also be appreciated that the outer screen 50 can also be controlled to display the same video that is being displayed by the inner screen 40, or other videos or information.

The promotional material can also be varied depending on the time of day.

Thus, a particular advantage of the present invention relates to the manner in which advertising to a particular demographic in a known, specific location and at a known, specific time can be controlled.

Since the pod is provided “out-of-home”, the strict guidelines governing the content and amount of advertising that can be tied in with televised programs and films and with films screened in movie theatres does not apply. The pod therefore represents a unique opportunity for advertisers of goods and services enjoyed by small children. Of course, advertisements may be included in the videos or on the menu screens displayed by the inner screen 40.

In a further embodiment, the outer surface of the video pod 1 can be branded, for example using a vinyl wrap, in a promotion of that brand. As an example, the pod 1 can be branded as a cornflakes packet and the promotional messages displayed by the inner and/or outer screens may be tied to the promoted brand. Moreover, vouchers printed by the printer 118 may be for discounts or special offers relating to the promoted brand.

As another example, the promotion may relate to a movie nearing its release date at movie theatres. The pod 1 may be decorated with promotional images for the movie, for example using a vinyl wrap. Either or both of the inner and outer screens 40, 50 may show excerpts from the movie or other related video and the printer may print vouchers offering a discount at the nearest (or any other) movie theatre on the release date or another date or range of dates.

Similarly, the promotion may relate to a movie nearing its DVD release date and vouchers may be for discounts for buying the DVD on launch day.

It should be noted that here, as in other embodiments, there is no requirement to limit the videos as being directed to children between 2 and 6 years old—videos may directed to other age ranges, including to adults. Sometimes, the same particular pod may be used for showing videos to young children and at other times to run promotions directed at adults.

The foregoing description has been given by way of example only and it will be appreciated by a person skilled in the art that modifications can be made without departing from the spirit and scope of the present invention.

By way of non-limiting example only, the pod 1 could be realized as a unitary molding, the unitary molding including one or more of the side and back walls, the roof and the floor. Naturally, different components may be disposed in different locations within the pod—for example, the bench may be provided on the second side wall 20 and the inner touch screen 40 on the first side wall 10.

The speakers 45, 55 may be disposed anywhere inside and outside the pod respectively, the only requirement being that a user perceives the sound from the inner speaker 45 in relation to the video shown on the inner screen 40 and the sound from the outer speaker 55 in relation to the images shown on the outer screen 50.

In the foregoing, video to be screened on the inner display screen 40 is selected using an inner touch screen 40. However, the inner screen 40 need not be a touch screen and other input devices such as keyboard, track ball and joystick may all be used as well as or instead of the touch screen 40.

In addition, although the apparatus for selecting video is preferably provided inside the pod, it may also or instead be provided on the outside of the pod, for example by providing the outer screen 50 as a touch screen. In this respect, it should be noted that the outer screen 50 may be controlled to show the video that is being shown inside the pod, related video, unrelated video or even video selected by the user separately from the video being shown inside the pod 1. The video shown outside the pod 1 may comprise exclusively promotional material or promotional material interspersed with other material chosen for or selected by the user.

Irrespective of whether they are touch screens or not, the inner and outer display screens 40, 50 may be LCD, OLEO, cathode ray or any other screen suitable for display changing images.

It is preferred that the printer 118 is a thermal printer. However, any kind of printer may be used, such as an ink jet printer or a laser printer.

It should be noted that the outside speakers 55 are not required if only silent promotional material is shown on the outside screen 50.

Although the foregoing description as been given with respect, to the display of videos relating to children's programs and films, it should be noted that the inner screen 40 can be used for game display. In this case, I/O devices 118 will include gaming control inputs, which again may be in the form of the/a touch screen, joystick, keypad and so on.

In addition, although update of the contents of the video pod has been described in terms of replacing a flashcard with more up-to-date data, it is possible to store all the data on a permanent nonvolatile storage 110 and to update via means of a modem, satellite, wi-fi, LAN, WAN or any other suitable link.

1. A children's entertainment apparatus comprising:
an enclosure comprising first and second side walls opposite one another, a back wall disposed between the first and second side walls, and a roof;
a first display device arranged to show video and provided inside the enclosure, a viewing space being provided inside the enclosure for viewing the first display apparatus; and
a second display device arranged to show video and provided on the roof.

2. A children's entertainment apparatus according to claim 1, a centerline of the second display device being disposed substantially at eye height of a normal human adult.

3. A children's entertainment apparatus according to claim 1, the centerline being disposed between 1 m and 2 m from a bottom of the apparatus.

4. A children's entertainment apparatus according to claim 3, the centerline being disposed between 1.3 m and 1.7 m from the bottom of the. apparatus.

5. A children's entertainment apparatus according to claim 1, the first display device being a touch screen arranged to provide menu options for selecting the video to be shown on at least the first display device.

6. A children's entertainment apparatus according to claim 1, further comprising a control for selecting the video to be shown on the second display device.

7. A children's entertainment apparatus according to claim 6, the control being the first display device.

8. A children's entertainment apparatus according to claim 1, further comprising a Bluetooth device.

9. A children's entertainment apparatus according to claim 8, a range of transmission of the Bluetooth device being substantially within a radius of 2 m of the apparatus.

10. A children's entertainment apparatus according to claim 8, the Bluetooth device being arranged to transmit promotional messages and, on receipt of a predetermined response, to cause the entertainment apparatus to print a promotional voucher.

11. A children's entertainment apparatus according to claim 1, further comprising a printer arranged to print promotional vouchers.

12. A children's entertainment apparatus according to claim 1, an opening being disposed opposite the back wall, whereby a carer of a child can see a child in the viewing space.

13. A children's entertainment apparatus according to claim 12, wherein the second display apparatus is disposed above the opening.

14. A children's entertainment apparatus according to claim 1, the maximum height of the apparatus being less than 1.7 m,

15. A children's entertainment apparatus according to claim 1, comprising a removable memory card on which the video is substantially stored.

16. A video pod comprising:
side walls and a roof;
a first display device inside the video pod;
a second display outside and above an opening to the pod;
a payment device;
an input device; and
a memory storing a plurality of video programs,
the first display device being arranged to display a selected one of said video programs upon payment via the payment device and selection via the input device by a user, and
the second display device being arranged to display a promotional video different to the video programs.

17. A video pod according to claim 16, at least the side walls being covered in a vinyl wrap.

18. A video pod according to claim 16, further comprising a dispenser for dispensing a voucher for a promotion.

19. A video pod according to claim 16, at least the side walls being covered in a vinyl wrap comprising a promotional image, the pod further comprising a dispenser for dispensing a voucher for a promotion associated with the promotional image.

20. A video pod according to claim 16, the promotional video displayed by the second display device corresponding to the selected video program.

21. A method for promoting articles, comprising:
providing at least one of a children's entertainment apparatus according to 1 and a video pod according to claim 17;
disposing a promotional image on the outside of the at least one of the children's entertainment apparatus and the video pod;
causing the first display screen to show a video associated with the promotional image; and
causing the second display screen to display an image associated with the promotional image.

22. A method according to claim 21, further comprising causing a dispenser to dispense a voucher associated with the promotional image.
